(19) United States
(12) Patent Application Publication
(10) Pub. No.: US 2002/0071584 A1
(43) Pub. Date: Jun. 13, 2002

(54) Hearing aid which can be worn behind the ear

(76) Inventors: Claus Rudolph, Ruegland (DE); Andre Schelbach, Detmold (DE)

Correspondence Address: SCHIFF HARDIN & WAITE, 6600 SEARS TOWER, 233 S WACKER DR, CHICAGO, IL, 60606-6473, US

(21) Appl. No.: 09/967,356

(22) Filed: Sep. 28, 2001

(30) Foreign Application Priority Data
Sep. 29, 2000 (DE) 100 48 336.4

(51) Int. Cl. H04R 25/00

(52) U.S. Cl. 381/322

(57) ABSTRACT

In the case of a hearing aid (1) which can be worn behind the ear, the housing is subdivided into at least two housing subregions (2, 3). Each housing subregion (2, 3) comprises at least one hearing-aid module. The housing subregions (2, 3) are adjustable in relation to one another and a switching function is performed by the adjustment of the subregions.

### BACKGROUND OF THE INVENTION

1. Field of the Invention

The invention relates to a hearing aid which can be worn behind the ear, with a housing which is subdivided into at least two interconnected housing subregions.

2. Description of the Related Art

European patent document EP 0 337 195 A2 discloses a hearing aid with a housing worn behind the ear which comprises a microphone, a single- or multi-stage amplifier, at least one volume control, one or more precontrols, an earphone and a housing chamber accommodating the battery. The housing of the known hearing aid is made up of a plurality of electrically and mechanically detachably interconnected housing modules.

DE 33 29 473 A1 discloses a hearing aid to be worn at the ear. The housing of this device is composed of a part that is referred to as “housing” and of a cover. The cover is seated rotatable around a hollow shaft and interacts with an on/off switch given a rotary motion.

DE 196 33 321 A1 discloses a hearing aid having a housing comprising an acoustic amplifier device and having at least one externally operable adjustment element for controlling the operating mode of the amplifier device, whereby the adjustment element comprises a trough formed in a region of the housing.

DE 41 16 533 C1 discloses a hearing aid to be worn at the ear lobe and having an articulation. An on/off switch can be provided in or at the articulation.

DE 37 42 887 A1 discloses a hearing aid having a hearing aid housing and an auxiliary housing. The auxiliary housing is fashioned in the form of a known audio shoe and serves the purpose of accommodating a receiver for a wireless drive.

The miniaturization aimed for in the case of hearing aids has disadvantageous effects on their operability, since the space available on the hearing aid housing for the attachment of operator control elements is very confined.

### SUMMARY OF THE INVENTION

The object of the present invention is to provide a hearing aid which can be worn behind the ear that addresses these issues of operability.

This object is achieved by a hearing aid which can be worn behind the ear, with a housing which is subdivided into at least two interconnected housing subregions, by the subregions being adjustable in relation to one another and permitting a switching function to be performed by the adjustment of the subregions.

It is advantageous for operating the inventive hearing aid, that instead of having relatively small operator control elements, subregions of the housing are adjustable in relation to one another. By analogy with actuating an operator control element in the case of a conventional hearing aid, adjusting the housing subregions in the case of the inventive hearing aid brings about a switching function. The fact that the housing subregions are relatively large in comparison with conventional operator control elements has the effect that not only is the actuation made easier, but it is also comparatively easy to identify the “switching position” (for example “on” or “off”) at the time from the position of the housing subregions in relation to one another.

A hearing aid in which all of the operator control elements are designed in the inventive way consequently has a smooth housing surface which is not interrupted by operator control elements. As a result, the hearing aid is very robust and can be protected well against contamination by dirt or moisture. It is therefore ideally suited particularly for children.

The housing subregions of the hearing aid preferably comprise at least one functional unit and consequently form a hearing-aid module. For example, one housing subregion may have at least one microphone, an earphone and the signal processing unit. Another may have the voltage supply and yet another may comprise the amplifier unit of the hearing aid. The hearing aid designed in this way consequently has a modular construction with an acoustic module, power module and amplifier module. This construction allows the appliance to be produced cost-effectively, and the individual devices can be assembled in accordance with requirements from prefabricated modules of specific power stages. Furthermore, it is possible to provide easy customer-service maintenance of the hearing aid.

According to one embodiment of the invention, housing subregions are rotatable in relation to one another to perform a switching function. The actuation of this hearing aid is consequently extremely easy. One housing subregion is firmly held by one hand and the housing subregions are rotated counter to one another to perform the switching function. The technical implementation of this embodiment is also simple. The housing subregions just have to be mounted on a common axis about which they can be turned in relation to one another. If the hearing aid is configured in such a way that the two housing subregions have to be rotated relatively far counter to one another to perform the switching function, the switching position at the time is advantageously directly evident from the outside. If it is intended for even relatively small movements to lead to the performance of a switching function, small markings on the housing subregions can indicate the switching position chosen at the time.

According to another embodiment of the invention, the housing subregions are pivotable in relation to one another for performing a switching function. This embodiment provides that both the performance of the switching function and the identification of the switching state at the time are easily possible.

The above embodiments may also be combined. For instance, in the case of a hearing aid with at least three modules, two may be rotatable counter to one another and two may be pivotable in relation to one another, or in the case of a hearing aid with at least two modules, they may be rotatable and pivotable in relation to one another, it then being possible for different switching functions to be performed by adjusting the modules in relation to one another.

In the switched-on state, the hearing aid according to the invention has a smooth contour in the transitional region between the housing subregions and, in the switched-off state, the contour of the housing has an irregular profile (this profile may be a discontinuous or disjointed curve, having multiple segments)—thus, it is easy to see whether the hearing aid is switched on or off.

In a further embodiment of the invention, the housing subregions lock in certain positions in relation to one another when a switching function is performed. The transition from one locked position into another is only possible by exerting an external force. The locking prevents unintentional switching operations and ensures that a defined, externally evident switching position is always set.

According to a preferred embodiment of the invention, housing subregions are detachably interconnected. If, for example, one housing subregion comprises the voltage source of the hearing aid, the power module designed in this way can be exchanged more easily. This dispenses with the need to actuate a battery compartment for the removal or re-insertion of a battery or a storage battery, which makes handling very much easier, particularly for children or elderly people.

The invention provides a further possibility by providing housing subregions of the hearing aid that are adjustable in relation to one another to a certain extent without a switching function being performed by this. For example, the “on” switching position can be assigned to a number of lockable positions of the housing subregions in relation to one another. As a result, the hearing aid can be adapted to the individual anatomical features of the person wearing the hearing aid. Only a relatively great deflection would lead to the switching function being performed.

### DESCRIPTION OF THE DRAWINGS

The invention is explained in more detail below on the basis of an exemplary embodiment and the drawings below.

FIG. 1 is a pictorial block diagram showing a hearing aid which can be worn behind the ear and is subdivided into two housing subregions, in the switched-on state;

FIG. 2 is a pictorial diagram of the hearing aid according to FIG. 1 in the switched-off state; and

FIG. 3 is a pictorial diagram showing two housing subregions separated from one another.

### DETAILED DESCRIPTION OF THE INVENTION

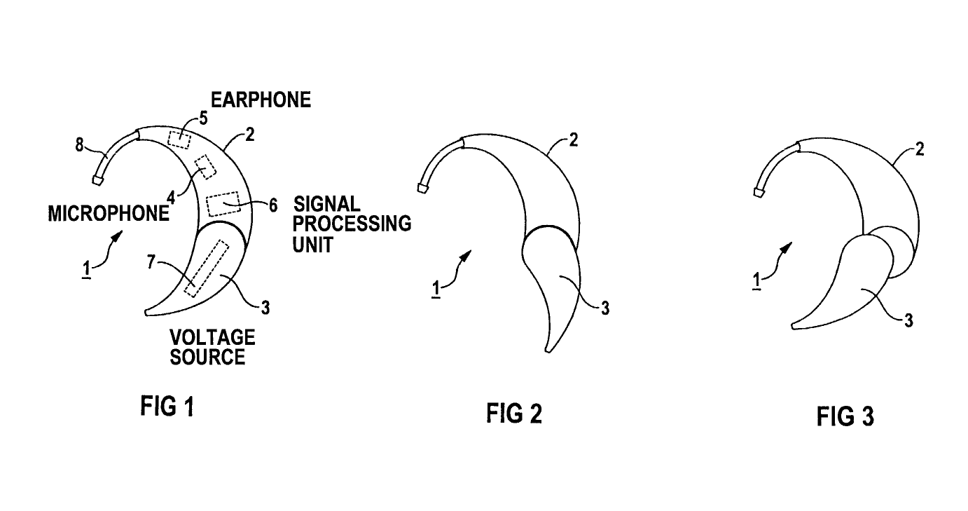

FIG. 1 shows a hearing aid 1 which can be worn behind the ear and the housing of which is subdivided into two housing subregions 2, 3. In the position represented of the housing subregions, the hearing aid 1 is in the switched-on state. The housing according to FIG. 1 has a smooth contour overall. In the exemplary embodiment represented, the housing subregion 2 comprises a microphone 4, an earphone 5 and a signal processing unit 6, and consequently forms the “hearing-aid module”. The housing subregion 3 comprises the voltage source 7, for example a battery, and consequently forms the power module. Furthermore, the hearing aid 1 has a supporting hook 8.

FIG. 2 shows the hearing aid according to FIG. 1 in the switched-off state. The irregular profile of the contour of the hearing-aid housing, particularly in the transitional region between the two housing subregions 2 and 3, can be clearly seen in this switching state. Consequently, the switching state of the hearing aid at the time can be easily identified by simply looking at the appliance. For switching the hearing aid on and off, a pivoting movement of the housing subregions in relation to one another has to be performed. It may be possible for further functions of the hearing aid to be set, for example via a remote control unit.

The inventive hearing aid can be protected well against moisture and soiling and altogether, and forms a very robust housing because it does not have any operator control elements of a customary type and, as a result, the housing shell does not have any, or only very few, openings (for example for the microphone).

FIG. 3 shows the two electrically and mechanically separated housing subregions 2 and 3. The separating of the housing subregions can preferably only be carried out in the switched-off switching position. Another possibility is that, in addition to the two switching positions “on” and “off”, a further position is provided, into which the housing subregions must be brought for separation. For changing the battery, the complete power module can consequently be changed, and this can be performed easily and safely (e.g., even by children).

The above-described hearing aids are illustrative of the principles of the present invention. Numerous modifications and adaptations will be readily apparent to those skilled in this art without departing from the spirit and scope of the present invention.

What is claimed is:

1. A hearing aid which can be worn behind the ear, comprising:
a housing which is subdivided into at least two interconnected subregions, a transitional region being present between said subregions, said subregions being pivotable relative to one another and having a switching function resulting from pivot motion of said subregions relative to one another, wherein in a first switching position, said housing of said hearing aid has at least approximately a smooth contour in said transitional region and, in a second switching position, said contour of said housing has an irregular profile.

2. The hearing aid which can be worn behind the ear as claimed in claim 1, wherein each of said subregions comprise at least one functional unit of the hearing aid.

3. The hearing aid which can be worn behind the ear as claimed in claim 1, wherein said hearing aid is switched on in said first switching position and switched off in said second switching position.

4. The hearing aid which can be worn behind the ear as claimed in claim 1, further comprising a locking mechanism permitting said subregions to lock in certain positions in relation to one another when said subregions are adjusted, and said locking can only be overcome by exerting an external force.

5. The hearing aid which can be worn behind the ear as claimed in claim 1, wherein said subregions are detachably or releasably connected to one another.

6. A method for operating a hearing aid that can be worn behind the ear, comprising the steps of:
providing a housing which is subdivided into at least two interconnected subregions, a transitional region being present between said subregions;
adjusting a first subregion to a first switching position to provide a first operating state of said hearing aid; and
adjusting said first subregion to a second switching position to provide a second operating state of said hearing aid.

7. The method for operating a hearing aid which can be worn behind the ear as claimed in claim 6, wherein said first operating state of said hearing aid is a power on condition and said second operating state of said hearing aid is a power off condition.

8. The method for operating a hearing aid which can be worn behind the ear as claimed in claim 6, wherein each step of adjusting said first subregion comprises at least one of rotating and pivoting said first subregion with respect to said second subregion.

9. The method for operating a hearing aid which can be worn behind the ear as claimed in claim 6, further comprising the steps of:
locking respective positions of said subregions with a locking mechanism; and
applying an external force to overcome said locked respective positions of said subregions.
